(19) United States
(12) Patent Application Publication
(10) Pub. No.: US 2009/0092953 A1
(43) Pub. Date: Apr. 9, 2009

(54) Encoding, Storing and Decoding Data for Teaching Radiology Diagnosis

(76) Inventors: Guo Liang Yang, Singapore (SG); Aamer Aziz, Singapore (SG); Narayanaswami Banukumar, Singapore (SG); Ananthasubramaniam Anand, Singapore (SG)

Correspondence Address: Bell, Boyd & Lloyd LLP, 3580 Carmel Mountain Road, Suite 200, San Diego, CA, 92130, US

(21) Appl. No.: 12/083,789

(22) PCT Filed: Oct. 20, 2006
(86) PCT No.: PCT/SG2006/000310

§ 371 Date: Nov. 24, 2008

Related U.S. Application Data
(60) Provisional application No. 60/728,745, filed on Oct. 21, 2005.

(51) Int. Cl. G09B 19/24

(52) U.S. Cl. 434/219

(57) ABSTRACT

Electronic data for presenting images to teach radiology diagnosis are stored on a computer readable storage medium. The stored data includes an image table that includes indexed radiology images to be displayed; a frame table that includes frame entries, each for displaying a frame in a sequence of frames to be displayed and comprising a time indicator indicating a time to display the frame in the sequence, and display state data indicating a display state of one of the radiology images to be displayed in the frame; at least one annotation table including data defining teaching annotations to be superimposed on at least one radiology image. Each frame entry is associated with a radiology image and each annotation table is associated with a frame entry. An encoder/decoder is provided for encoding and storing the data in a file and for decoding and presenting images formed from the data.

### FIELD OF THE INVENTION

The present invention relates to storing electronic data for teaching radiology diagnosis.

### BACKGROUND OF THE INVENTION

Electronic teaching files (ETFs) based on radiological images have been used for radiology teaching. Conventional ETFs for radiology teaching contains texts and references to still radiology images. It is desirable to provide a more effective teaching tool using ETFs that incorporates video or animated data and, optionally, audio data. However, conventional methods of encoding digital video data tend to result in large data files. As can be appreciated, larger data files take more storage space to store and take longer time to transmit over a communication channel such as over a network. To solve this problem, a conventional technique is to compress the digital video data. However, over compression can result in reduced resolution. Teaching radiology diagnosis with radiology images of sufficiently high resolution is more effective than with low resolution images in many cases. Low resolution images may also discourage users from using the teaching files.

### SUMMARY OF THE INVENTION

According to a first aspect of the present invention, there is provided a method of storing electronic data for presenting images to teach radiology diagnosis. The method comprises, on a computer readable storage medium: storing an image table that comprises indexed radiology images to be displayed; storing a frame table that comprises frame entries, each for displaying a frame in a sequence of frames to be displayed and comprising a time indicator indicating a time to display the frame in the sequence, and display state data indicating a display state of one of the radiology images to be displayed in the frame; storing at least one annotation table comprising data defining teaching annotations to be superimposed on at least one of the radiology images; associating each frame entry with one of the radiology images; and associating each annotation table with one of the frame entries. The tables may be stored in an electronic file for teaching radiology diagnosis. The tables may be generated, at least in part, to record a user's visual manipulation of the radiology images. At least one of the radiology images may be copied from a pre-existing image data file. The image table may be generated at least in part according to a preexisting electronic teaching file, the teaching file comprising a reference to the image data file. The image data file may be stored in a database. The teaching annotations may comprise one or more annotation items selected from an arrow, a line, a polygon, an ellipse, and a text string. The line may be a straight line. The polygon may be a triangle, or a square, or a rectangle. The ellipse may have a major axis and a minor axis equal to or shorter than the major axis. The method may comprise storing audio data for presenting audio instructions synchronously with the sequence of frames. The audio data may be stored in an audio data file. The method may comprise storing a frame rate indicator indicating a number of frames to be displayed in a unit time. The method may comprise storing viewport data indicating a viewport for the frames. The method may comprise storing a key node table. The key node table may comprise one or more key node entries, each key node entry comprising a description of a key node and a time indicator that matches a time indicator of a frame entry associated with the each key node. Each frame entry may comprise a sequence number. Each frame entry may comprise cursor data for displaying a cursor. The annotation table may comprise at least one annotation entry, each annotation entry comprising annotation data for displaying an annotation item. The annotation entry may comprise a type indicator indicating a type of an annotation item in the annotation entry. Each frame entry may comprise an image indicator indicating an image index of a radiology image associated with the frame entry. The display state data may comprise an indicator of at least one of brightness, contrast, and a zoom factor for an associated image.

According to another aspect of the present invention, there is provided a method of presenting images using data stored according to the method described in the preceding paragraph. The current method comprises: displaying the sequence of frames based on the tables, wherein a particular one of the frames is displayed by displaying a radiology image associated with the corresponding frame entry according to the corresponding frame entry, and superimposing a teaching annotation on the radiology image according to an annotation table associated with the corresponding frame entry. The particular frame may be displayed at a time indicated by the time indicator of the corresponding frame entry. The method may comprise presenting audio annotation based on stored audio annotation data, as the frames are displayed. The audio annotation may be presented in synchronization with presentation of the sequence of frames.

According to a further aspect of the present invention, there is provided a computer readable storage medium storing data for presenting images to teach radiology diagnosis. The data comprises an image table that comprises indexed radiology images to be displayed; a frame table that comprises frame entries, each for displaying a frame in a sequence of frames to be displayed and comprising a time indicator indicating a time to display the frame in the sequence, an image indicator indicating an image index to associate the frame with one of the radiology images to be displayed in the frame, and display state data indicating a display state of the one of the radiology images to be displayed in the frame; at least one annotation table comprising data defining teaching annotations to be superimposed on at least one of the radiology images, each annotation table associated with one of the frame entries. The data may be stored in an electronic file. The teaching annotations may comprise one or more annotation items selected from an arrow, a line, a polygon, an ellipse, and a text string. The line may be a straight line. The polygon may be a triangle, or a square, or a rectangle. The ellipse may have a major axis and a minor axis equal to or shorter than the major axis. The computer readable storage medium may also store audio data for presenting audio annotation of the radiology images. The data may comprise a frame rate indicator indicating a number of frames to be displayed in a unit time. The data may comprise viewport data indicating a viewport for the frames. The data may comprise a key node table, the key node table comprising one or more key node entries, each key node entry comprising a description of a key node and a time indicator that matches a time indicator of a frame entry associated with the each key node. Each frame entry may comprise a sequence number. Each frame entry may comprise cursor data for displaying a cursor. The annotation table may comprise at least one annotation entry, each annotation entry comprising annotation data for displaying an annotation item. The annotation entry may comprise a type indicator indicating a type of an annotation item in the annotation entry. Each frame entry may comprise an image indicator indicating an image index of a radiology image associated with the frame entry. The display state data may comprise an indicator of at least one of brightness, contrast, and a zoom factor for an associated image.

According to a further aspect of the present invention, there is provided an apparatus for teaching radiology diagnosis, comprising the computer readable storage medium described above, and a display in communication with the computer readable storage medium for displaying images based on the data.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures, which illustrate, by way of example only, embodiments of the present invention,

FIG. 1 is flowchart of a process for teaching radiology diagnosis, exemplary of an embodiment of the present invention;

FIG. 2 is a schematic diagram of a network system used in the process of FIG. 1;

FIG. 3 is an exemplary screenshot showing a radiological image to be manipulated;

FIG. 4 is a screenshot showing manipulation of the image of FIG. 3;

FIGS. 5 to 10 are block diagrams illustrating a file format, exemplary of an embodiment of the present invention;

FIGS. 11A to 11C show an exemplary file structure according to the format of FIGS. 5 to 10;

FIGS. 12 and 13 are flowcharts for an MMTF encoding process; and

FIG. 14 is a flowchart for an MMTF decoding process.

### DETAILED DESCRIPTION

Embodiments of the present invention include methods and devices of storing electronic data for presenting animated images, which may be used for teaching radiology diagnosis.

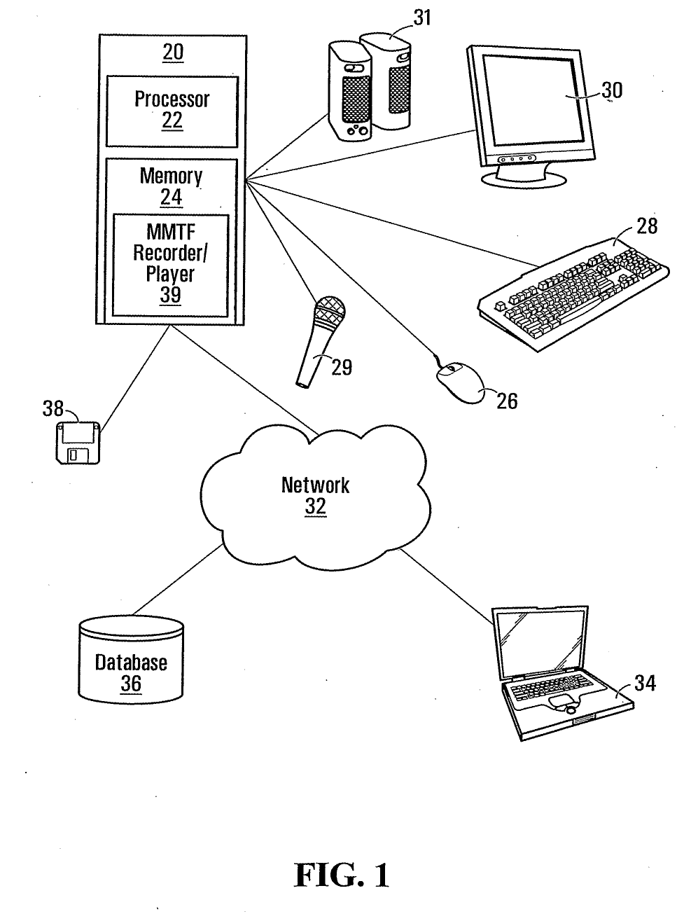

As shown in FIG. 1, an exemplary embodiment of the present invention includes a computer 20, which may include a processor 22 in communication with a memory 24. Computer 20 may include input/output devices such as mouse 26, keyboard 28, microphone 29, monitor 30, speaker 31, and the like. Computer 20 may communicate with a network 32, another computer 34, and an electronic database 36.

Processor 22 can be any suitable processor including microprocessors, as can be understood by persons skilled in the art. Processor 22 may include one or more processors for processing data and computer executable codes or instructions.

Memory 24 may include a primary memory readily accessible by processor 20 at runtime. The primary memory may typically include a random access memory (RAM) and may only need to store data at runtime. Memory 24 may also include a secondary memory, which may be a persistent storage memory for storing data permanently, typically in the form of electronic files. The secondary memory may also be used for other purposes known to persons skilled in the art. Memory 24 can include one or more computer readable media. For example, memory 24 may be an electronic storage including a computer readable medium for storing electronic data including computer executable codes. The computer readable medium can be any suitable medium accessible by a computer, as can be understood by a person skilled in the art. A computer readable medium may be either removable or non-removable, either volatile or non-volatile, including any magnetic storage, optical storage, or solid state storage devices, or any other medium which can embody the desired data including computer executable instructions and can be accessed, either locally or remotely, by a computer or computing device. Any combination of the above is also included in the scope of computer readable medium. For example a removable disk 38 may form a part of memory 24. Memory 24 may store computer executable instructions for operating computer 20 in the form of program code, including a multimedia teaching file (MMTF) player application 39, as will be further described below. Memory 20 may also store data such as operational data, input data, and output data, including image data and audio data.

The input and output devices of computer 20 may include any suitable combination of input and output devices. The input/output devices may be integrated or provided as separated components, and may be in communication with any number of input and output devices. The input devices may include a device for receiving user input such as user command or for receiving data. Example user input devices may include a keyboard, a mouse, a disk drive/disk, a network communication device, a microphone, a scanner, a camera, and the like (some of these are not shown). Input devices may also include sensors, detectors, or imaging devices. The output devices may include a display device such as a monitor for displaying output data to a user, a projector for projecting an image, a speaker for output sound, a printer for printing output data, a communication device for communicating output data to another computer or device, and the like, as can be understood by persons skilled in the art. The output devices may also include other devices such as a computer writable medium and the device for writing to the medium. An input or output device can be locally or remotely connected to computer 20, either physically or in terms of communication connection.

It will be understood by those of ordinary skill in the art that computer 20 may also include other, either necessary or optional, components not shown in the figures.

Network 32 may be any suitable communication network such as the Internet, a local area network or a wide area network, which interconnects database 36 and computers 20 and 34. The connection to network 32 may be made in any suitable manner as can be understood by persons skilled in the art.

Computer 34 may be similar or different from computer 20, and may have similar or different components. For example, one or both of the computers may be a desktop computer or a laptop computer or the like. Computer 34 may be located remote from computer 20, but is not necessarily so.

Database 36 may be any suitable electronic database for storing medical image data including radiology images. For example, database 36 may be a database at the Medical Image Resource Center (MIRC) of Radiological Society of North America (RSNA), a Picture Archiving and Communication System (PACS), or another database that stores image data compliant with the MIRCdocument Schema or the PACS, or the like. Database 36 may include more than one databases. More than one databases may be stored at different locations. In one embodiment, database 36 may also store electronic teaching files (ETFs) associated with the image files. A teaching file stored in database 36 may be in a conventional format. The image files and teaching files may be searchable.

As can be understood, additional devices and components such as computers, databases or electronic devices may be connected to network 32 or computer 20 or 34. The communication between any two of the devices or components shown in FIG. 1 may be through wired or wireless channels. Any two devices or components may communicate directly or indirectly. The hardware in any of the devices or components shown in FIG. 1 may be manufactured and configured in any suitable manner, as will be understood by one skilled in the art.

Memory 24 may store computer executable code, including instructions which, when executed by processor 22, can adapt or cause computer 20 to perform certain methods or tasks as described below. The computer code may be contained in MMTF player 39. Suitable code and software incorporating the code may be readily developed and implemented by persons skilled in the art.

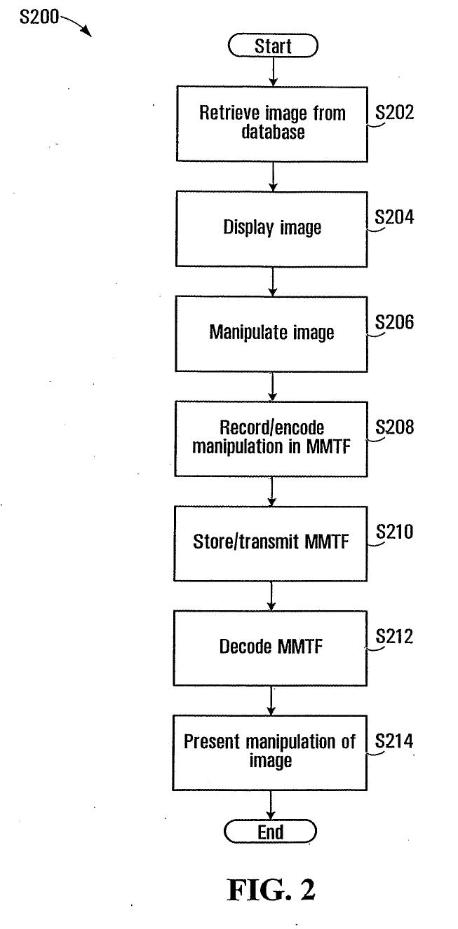

An exemplary embodiment of the present invention is related to a method (S200) of teaching radiology diagnosis, using ETFs, as illustrated in FIGS. 1 and 2.

At S202, a first user (not shown), such as an instructor, may cause computer 20 to retrieve one or more pre-existing radiology image data files from database 36, such as through network 34. The image files may be stored in memory 24. As can be appreciated, if the image files are already stored in memory 24, they may be retrieved directly from memory 24.

The retrieved image files may be referenced in an ETF, which also contains descriptive and teaching information for the corresponding radiology images. The image files may be retrieved automatically by computer 20 when the ETF is loaded at processor 22.

An ETF may be a script file, and may be compliant with any suitable scripting language or file format. For example, an ETF may be compliant with the Hyper Text Markup Language (HTML), or an Extended Markup Language (XML). As can be appreciated, another markup language other than an XML may also be used for the formatting the teaching file in different embodiments. The ETF may be any conventional ETF for teaching radiology diagnosis. In one embodiment, the teaching file may be compliant with the ETF format of the RSNA MIRC. The ETF may contain links to static radiological images. For example, a simplistic MIRC compliant ETF may contain the following, with a reference to a radiology image file:

...
<MIRCdocument>
<title> A Sample ETF Document </title>
<section head=”images”>
<image href=”radiology_image.jpg”> FIG. 1 </image>
</section>
</MIRCdocument>
...

where the file “radiology_image.jpg” may be stored on database 36.

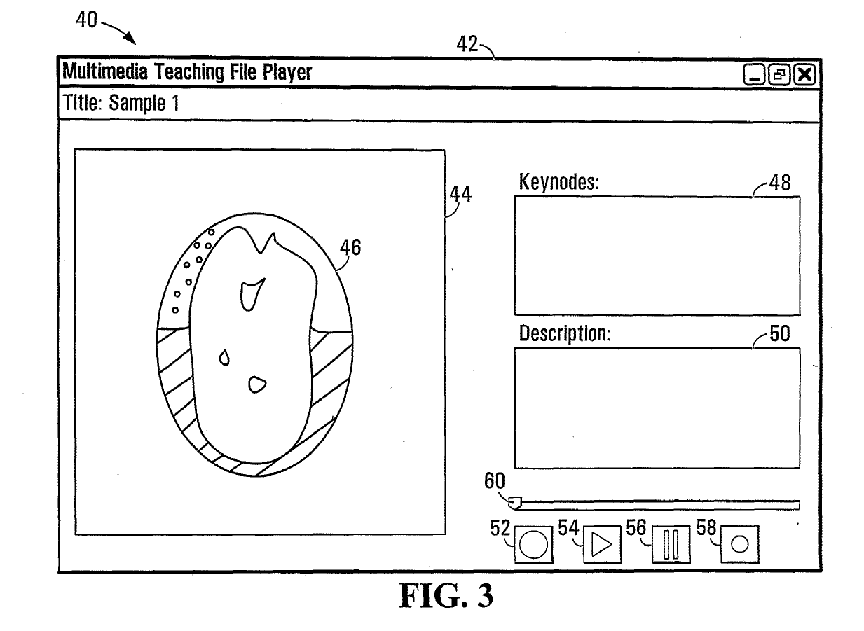

At S204, one or more retrieved images are selectively displayed, such as on monitor 30 as illustrated in FIG. 3.

FIG. 3 shows an exemplary screenshot 40 of a graphical user interface (GUI) 42 for a teaching tool, exemplary of an embodiment of the present invention. The teaching tool may include MMTF player 39, an MMTF recording and playing application, which can, in part, read a conventional ETF for teaching radiology diagnosis and display the relevant radiology images in a display region or viewport 44 in GUI 42 for manipulation by the first user. As shown, one image 46 is displayed. However, more images may be displayed at the same time. GUI 42 may also include one or more regions for inputting or displaying textual information about the displayed image(s). For example, as shown, a Keynode region 48 and a Description region 50 may be shown. The application may have recording and playback functionalities, which can be respectively activated such as by clicking on a recording button 52 or a playback button 54, the use of which will become clear below. Other conventional functionalities such as pause, stop, fast forward, fast backward, or the like may also be provided. For example, a pause button 56 and a stop button 58 are shown in FIG. 3. Also shown is a slider bar 60 for conveniently changing the current playing position. As can be appreciated, while it is not necessary that the MMTF recorder (or encoder) and player (decoder) be integrated in one application, such an integrated application may be convenient to use. For example, during a recording session, the user may wish to pause and replay what has been recorded before proceeding to the next step. The user may also wish to re-record a certain portion.

As can be appreciated, the radiology images may also be displayed on a different electronic display device such as a projection screen or a TV (not shown).

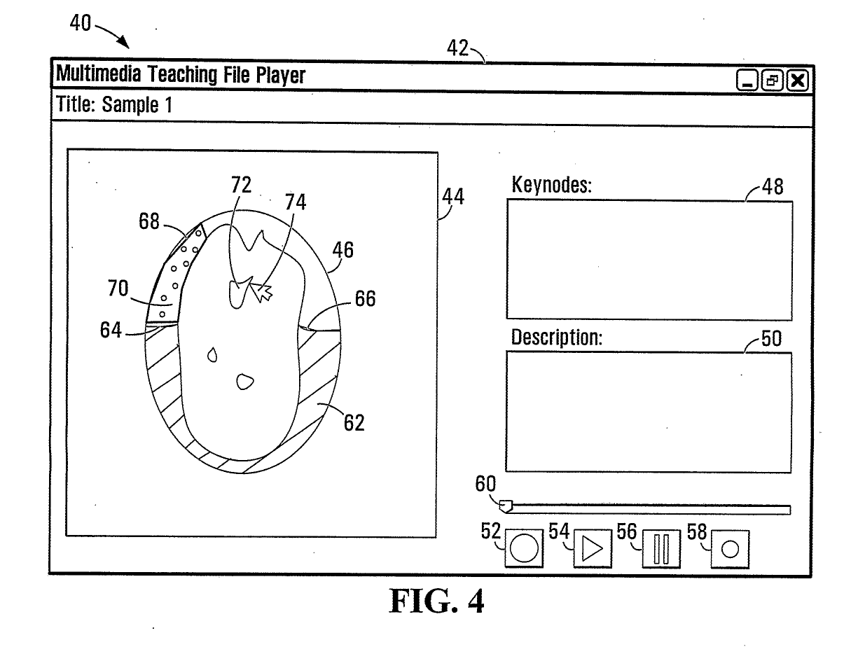

At S206 of FIG. 2 and as illustrated in FIGS. 3 and 4, the first user can manipulate a displayed image such as image 46 on monitor 30 to perform or demonstrate a radiology diagnosis of the image. The user may display the image in different display states, such as by varying the viewport, window level, zooming factor, panning, and the like, as can be understood by persons skilled in the art. The user may simultaneously or sequentially display more than one images. The user may selectively point to a certain portion of an image, such as with a cursor 74, or annotate an image with drawings or text during the manipulation. The user may manipulate the images using a pointing device such as mouse 26, keyboard 28, a drawing pad (not shown), or any suitable device. For example, when a projector is used, an optical pointer may be used as the pointing device. The manipulation of the image may have a visual component and an audio component. For example, the user may also provide verbal teaching annotations as a radiology image is manipulated. The verbal annotations may be recorded such as with the use of microphone 29 or another audio input device (not shown) connected to computer 20. The verbal annotation may also be initially recorded using a separate audio recording device such as a voice recorder (not shown).

For example, the user may explain verbally how a particular area is of interest while pointing at the particular area with a pointer such as cursor 74. The user may also visually delineate the boundary of an area of interest with lines or other geometrical shapes such as lines, arrows, circles, ellipses, triangles, squares, rectangles, and other polygons. As can be understood, a circle is a special ellipse whose major and minor axes are of equal length. An ellipse may have a minor axis less than its major axis. The area within the image or a delineating shape may be colored or shaded differently to highlight it.

For example, as shown in FIG. 4, the user may delineate the region 62 by lines 64 and 66, and draw a polygon 68 to delineate the region 70. As the lines are drawn, the user may explain verbally, for example, how each region 62 or 70 relates to the diagnosis of an anomaly in image 46. The user may also point to a certain region such as region 72 with cursor 74.

Other visual manipulation of the image is also possible as can be understood by persons skilled in the art. For example, such manipulation may include any and all possible manipulation of a radiology image that will assist the teaching and understanding of the diagnosis or conveying any information the user intends to communicate.

At the user's option, or based on the content of the associated ETF, the display state of image 46 may be changed during its manipulation, and the displayed image may also be changed.

At S208 of FIG. 2, the manipulation of the images, including the optional accompanying audio signal as such any verbal commentary or annotation, is recorded. The manipulation recorded may be encoded and stored in an MMTF. The recoding and encoding may be performed using an MMTF encoder such as MMTF recorder/player 39 illustrated in FIGS. 1, 3 and 4, as will be further described below. For simplicity recorder/player 39 is also referred to as player 39 below but it is understood that player 39 also includes a recoding and encoding portion and can perform the recording and encoding functions. As can be appreciated, the manipulation and recording may occur simultaneously. The recording of the manipulation may be performed utilizing a suitable conventional audio/video recording technique, with the exception explained below. The resulting MMTF will contain data for reproducing at least visually the manipulation process on an electronic display, such as on computer monitor 30 or on the monitor screen of computer 34. The verbal instructions may be optionally replayed such as through speaker 31 or a speaker connected to computer 34. The audio and visual teaching annotations may be replayed synchronously. In this regard, the MMTF may include both audio and visual data. In one embodiment, the audio and visual data may be stored in separate files. In another embodiment, the audio and visual data may be stored in the same file. The audio data may be recorded and stored according to any suitable technique, including a conventional audio recording and storing technique. The visual data may be recorded and stored according a scheme described below to reduce the file size.

At S210, the MMTF may be stored on memory 26 or disk 38. The file may also be transmitted to computer 34 or database 36, such as through network 32. As can be appreciated, smaller sized files can be transmitted more quickly and will take up less storage space, so they are more desirable in many cases than larger files. In some embodiments, the MMTF may be encoded in a way to reduce its size, as will be described further below.

A second user, such as a student (not shown), may later retrieve the MMTF and decode the MMTF (S212) to playback the recorded manipulation process (at S214) such as on computer 34.

The manipulation process may be replayed as a sequence of image frames that form animated images for teaching radiology diagnosis. The data for these image frames may be stored in one or more MMTFs.

As discussed above, it may be desirable to reduce the size of the MMTF in some cases. However, it may also be desirable at the same time to preserve the original resolution of the radiology images. An exemplary embodiment of the present invention is related to an encoding scheme or MMTF format for reducing the size of an MMTF without reducing the radiology image resolution.

In overview, the manipulation data is stored separately from, but in association with, the image data for the original radiology image. For example, the image data retrieved from database 36 may be stored in a section of the MMTF as is, without further compression. Manipulation data, which includes display state data indicating the display state of each image at any given time and annotation data for reproducing the teaching annotation made on the radiology images, may be stored in a separate section of the MMTF, and is not stored on a pixel-by-pixel or voxel-by-voxel basis. During playback, each displayed frame is constructed by superimposing annotation items constructed from the manipulation data on radiology images constructed from the image data. For a given frame, the file may contain a radiology image associated with the frame, the display state data associated with the frame to indicate how the radiology image is to be displayed in the given frame and annotation data associated with the frame to indicate what teaching annotation is to be superimposed on the displayed image, thereby producing a complete frame image that is substantially representative of an original screen snapshot.

In this scheme, the manipulation data may be structured to reduce size without affecting the resolution of the radiology images to be displayed. It is also not necessary to record and store the complete image data for each frame to be displayed. For example, when a radiology image is shown in multiple frames, only one copy of the radiology image data needs to be stored. It is sufficient to associate this image data with each frame that is to contain the radiology image. Again, the file size is reduced without scarifying the resolution of the displayed radiology image.

As can be appreciated, when the frames images are displayed in the proper sequence, optionally synchronized with the audio playback, the original manipulation of the radiology images can be at least substantially reproduced. When the audio annotation is played in synchronization with the animated visual images, the second user is exposed to a learning experience similar to a live lecture, thus enhancing the teaching and learning process.

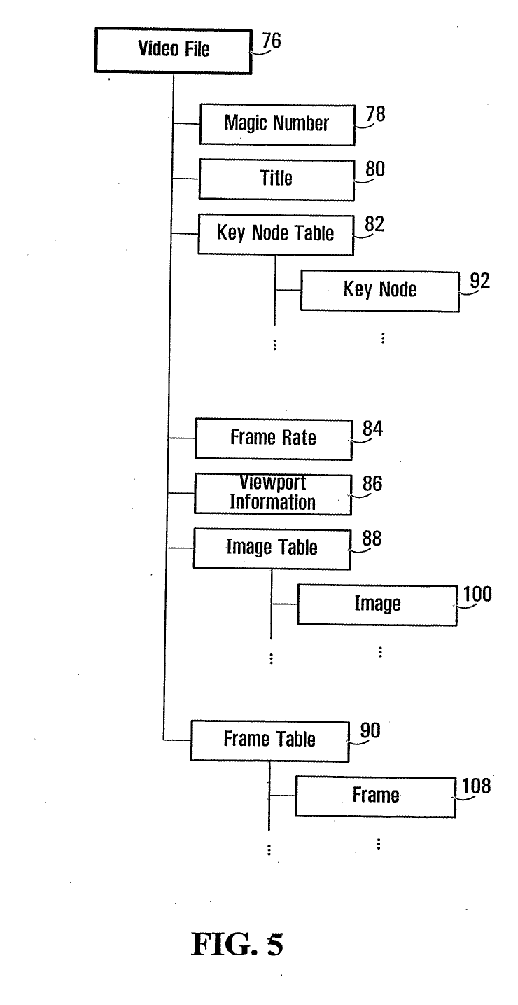

To further illustrate, a specific exemplary scheme for MMTF encoding is discussed next with reference to FIGS. 5 to 10.

In this exemplary scheme, the visual data and audio data are stored in separate files. The audio data may be stored in a conventional format for compressed audio files. For example, the audio file may be encoded using the Global System for Mobile Communications (GSM) encoding technique. As can be appreciated, the GSM encoding format provides a high compression rate and an acceptable audio quality for teaching radiological diagnosis.

The visual data file has a format exemplary of an embodiment of the present invention. The visual file is an electronic teaching file storing data for sequentially displaying a number of frames to present animated images for teaching radiology diagnosis. Each frame represents a screen snapshot, such as the ones shown in FIGS. 3 and 4, at a particular time during the manipulation of the images on a display screen such as monitor 30. The visual file contains data for constructing these frames. When the frames are displayed in the proper sequence, the original manipulation of the images is reproduced visually.

While the visual file may store binary data, the format of the file is explained herein using text for ease of understanding. The visual file may be referred to as a video file.

As shown in FIG. 5, at the top level, a video file 76 includes the following data sections: a Magic Number 78, a Title 80, a Key Node Table 82, a frame rate 84, viewport data 86, an Image Table 88, and a Frame Table 90. As used herein, the term “table” is to be interpreted broadly and may refer to any indexed data structure for storing indexed data. Each data entry may be indexed in any suitable manner, including by its position or sequential order in a file or on a storage medium.

Magic Number 78 indicates the type of the current file. For example, it may contain a string “MMT1”, indicating that video file 76 is an MMTF file.

Title 80 may contain the title information for file 76, which may be a text string.

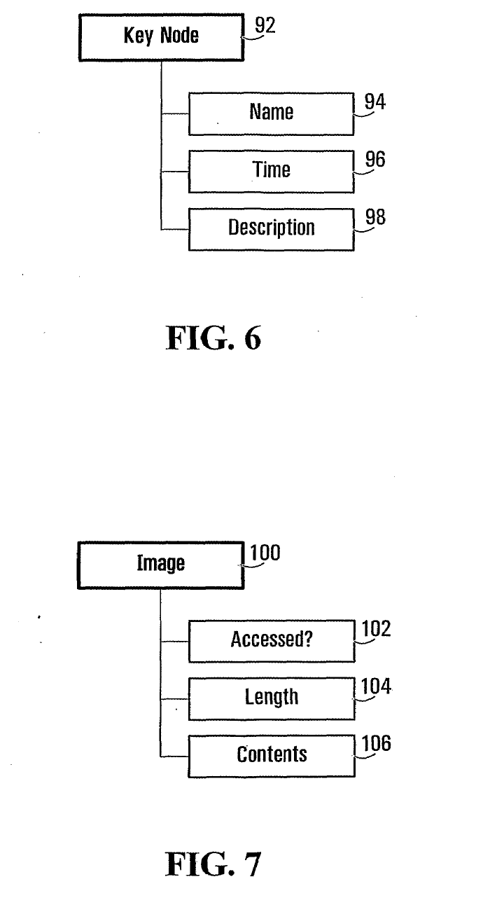

Key Node Table 82 contains entries for all key nodes 92. A key node is a significant transition point in the frame sequence. For example, a key node may be a point in the sequence where a new session is started, or a new radiological image is first displayed, or a new annotation is added, or the like. A teaching session may include an introduction segment, a description segment, a diagnosis segment, a conclusion segment, and the like. Each of these segments may be a key node in the teaching session. The key node table and key node entries provide a way for a user to quickly access any particular key node in the sequence. Thus, the key nodes may be used to index or mark the frames to be displayed so that, for instance, a user may conveniently access any key node directly, such as through the key node region 48 in FIGS. 3 and 4. As can be appreciated, the key node table is optional and may be omitted in some embodiments. As shown in FIG. 6, each key node 92 entry stores information about the key node, including its node name 94, time 96, and description 98. Node name 94 contains a string representing the name of the key node, which can be for example “Introduction”, “Description of Image”, “Diagnosis of Image”, “Conclusion”, or the like. Time 96 contains timing data indicating the start time of the key node. Description 98 contains descriptive information of the key node 92, which can be a string. The content of Description 98 may be displayed while the frames associated with a key node are being displayed in the Description region 50 of FIGS. 3 and 4.

Frame rate 84 indicates the maximum number of frames to be displayed per unit time. For example, the frame rate may be set at 10 to 15 frames per second. The frame rate may match the rate at which the manipulation of the image is captured during recording. For instance, if during recording a snapshot of the display screen is taken every 1/15 seconds and recorded, the frame rate for playback may be 15 frames per second.

Viewport data 86 includes data indicating the viewport for the frames or the images to be displayed. For example, a viewport may be a rectangular window for viewing a portion of an image. A viewport may also be a two-dimension (2D) window for viewing a 3D image. Viewport data may contain a height and a width for defining a window or viewport in which an image is to be displayed.

As illustrated in FIG. 5, image table 88 stores actual image data for radiological images to be included in the frames. Image data for each radiology image is stored in a separate image entry 100. Image table 88 may contain one or more image entries. The image entries may be explicitly indexed such as being associated with respective index numbers. Alternatively, the image entries may be implicitly indexed as they are sequentially stored in a file. In one embodiment, image table 88 may contain an image entry for each radiological image referred to in an associated ETF. In another embodiment, image table 88 may only contain image entries for images that are to be displayed. As can be appreciated, whether or not a particular image listed in the associated ETF file will be actually accessed by the user during the image manipulation process may not be determined until the process is concluded. If the recording and encoding are performed concurrently, the encoder does not know at the outset if any particular image is to be displayed in a frame. Thus, in one embodiment, an image entry is created and indexed for each image listed. However, the image data for a particular image will only be recorded in the video file when the particular image has actually been accessed. The image entries that do not contain image data are not deleted but kept to maintain the original image indexing, the benefit of which will become clear below. As can be appreciated, an empty image entry does not take much storage space.

As shown in FIG. 7, image entry 100 may include an access flag 102, a length indicator 104, and contents 106. In this case, no separate image index number is stored in the image entry as the image entries are sequentially stored. Access flag 102 indicates if the current image has ever been accessed during the recorded manipulation process. For example, Accessed Flag 102 may be set to ‘A’ when the image has been accessed, and to “a” when it has not. Other toggle values may be used instead of “A” and “a”.

If the original image file has not been accessed, no image data will be stored and length indicator 104 and Contents 106 may be omitted or may contain nil data. As can be appreciated, omitting image data for images that have not been accessed during recordation can reduce the file size and will not affect the playback of the recorded session.

If the original image file has been accessed, length indicator 104 may contain a value indicating the length of the image data, such as in number of bytes, and Contents 106 may contain the image data for a radiology image to be displayed. The image data for a radiology image may be copied from a still radiology image file, which may be retrieved from a medical database. The image file, as discussed earlier, may be referenced in the ETF. The image data may be stored in its original format without any further compression. The original image file for each radiology image may have any suitable image format, including the Analyze format (AVW, or HDR/IMG), Bitmap (BMP), Digital Imaging and Communications in Medicine (DICOM), Graphic Interchange Format (GIF), Joint Photographic Experts Group (JPEG), JPEG 2000, Portable Network Graphic (PNG), PNM, PPG, RGB, RGBα, Silicon Graphic Incorporation (SGI), Tagged Image File Format (TIFF), and the like. As is typical, the data format of the image data may be pixel-by-pixel or voxel-by-voxel based, depending on whether the image is 2D or 3D.

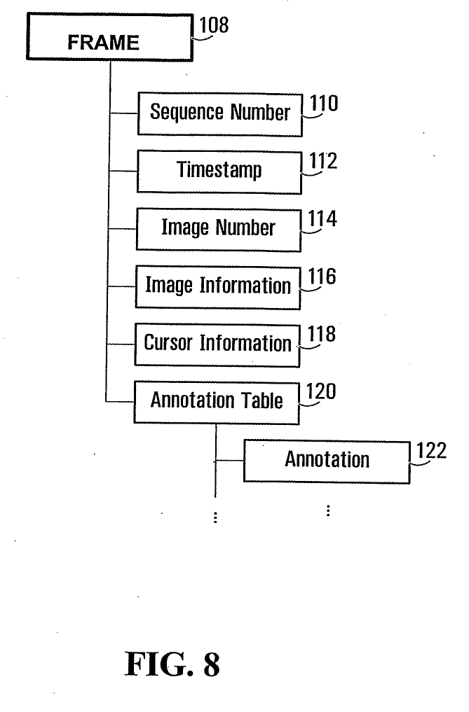

Frame table 90 includes frame entries 108 for image frames to be displayed in a defined sequence. As illustrated in FIG. 8, each frame entry 108 contains the data for a frame to be displayed during playback, including a sequence number 110 and a Timestamp 112. If a frame to be displayed is different from the preceding frame, its associated frame entry 108 may contain additional data for displaying the frame, such as an Image Number 114, Image Information 116, Cursor Information 118, and an Annotation Table 120. When a frame is exactly the same as a previous frame, the associated frame entry 108 may contain only a flag indicating that the data for the immediately preceding frame is to be used, or contain only a pointer pointing to the previous frame, such as the sequence number of the previous frame. As can be appreciated, using a flag or pointer in this way can significantly reduce the file size.

Sequence number 110 is a sequence index indicating the frame's position in the entire sequence of the frames to be displayed. The sequence numbers may also be used for random-accessing the frames.

Timestamp 112 indicates the time at which this frame is to be displayed, and may also serve as a sequence index. For example, the first three frames in the sequence may be respectively displayed at 0.1, 0.2, and 0.3 seconds. In this case, the timestamp for the first three frame entries may have respective values of 0.1, 0.2 and 0.3. During playback, the frames may be displayed primarily according to the timestamps. However, certain frames may be skipped if the total number of frames displayed per unit time exceeds the frame rate indicated by frame rate 84. For instance, when the frame rate is set at 10 frames per second and according to the timestamps 12 frames are to be displayed in one second, the last two frames may be omitted. The frame rate 84 may be useful for avoiding certain playback problems. For instance, during playback, the computer that decodes and displays the frames may not have sufficient processing power to display all of the frames if the frame rate is too high. In such a case, limiting the maximum number of frames displayed per second may resulting in a better animated frame sequence.

The time 96 of a key node entry may match a timestamp 112 of a frame entry. Thus, the starting frame for the particular key node is the matched frame.

Image Number 114 is a pointer to the image entry that contains the image data for the radiology image to be displayed in this particular frame, and may include the image index of the relevant image entry. Other indicator for indicating the associated image index or image entry may be used.

Image Information 116 may contain display state data indicating the display state of the radiology image to be displayed. For example, display state data may include data indicating one or more of the brightness, contrast, offsets (such as in terms of x-y coordinates of a corner of the viewport or window), zoom factor, and the like, for an associated image. As can be understood, in a gray-scale image, the brightness and contrast of a displayed image may be automatically adjusted when the dynamic pixel gray scale range is defined. Thus, the display state data may contain an indicator of the minimum window gray scale and an indicator of the maximum window scale.

Cursor Information 118 may contain a binary flag indicating whether a cursor is to be displayed within the viewport of the radiology image, data indicating the shape of the cursor to be displayed, and the cursor position such as its x-y coordinates.

Annotation Table 120 may contain data for displaying teaching annotations, such as annotation items, to be superposed on the radiology image in this frame. Data for each annotation item is contained in an annotation entry 122. For each frame entry, there may be any number of annotation items. For example, there may be no annotation item, or one or multiple annotation items. In one embodiment, a frame entry 108 may contain an indicator indicating the number of annotation entries associated with the frame, or the number of annotation items to be displayed in the frame. If no annotation is present in the frame, the annotation table may be omitted.

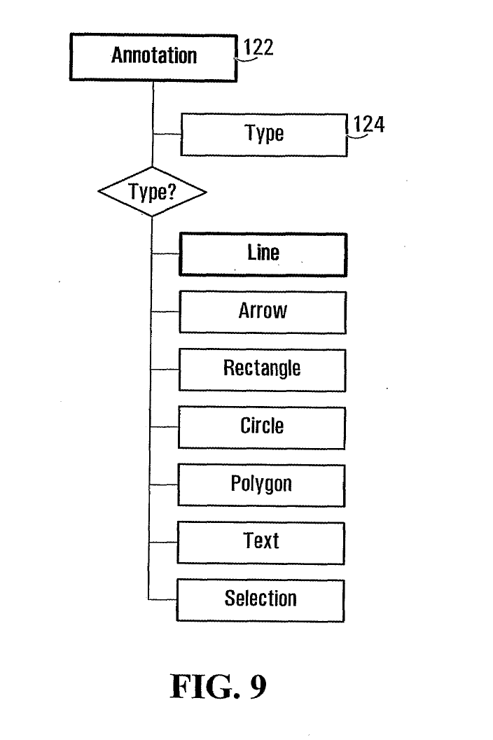

As shown in FIG. 9, an annotation item can be of different types or shapes, such as lines, arrows, rectangles, circles, polygons, text string, and the like.

Optionally, one or more annotation items within a region of a frame may be selected and grouped as a collective by a user. The selected region may be marked such as by a box or circle of broken lines. Thus, a special type of annotation item may be included in the annotation table which is referred to as a “Selection”. A selection annotation item may include data for defining a region to indicate that every annotation item within the region is “selected”. For example, the data may include data for displaying a box or circle that consists of broken lines to distinguish from a normal annotation. As can be appreciated, the selected region may have any suitable shape. The “selected” annotation items in the region can be processed collectively. For instance, a selection box can be dragged by the user to another location with all the annotation items in it. Alternatively, a selection box can be cut or copied and pasted elsewhere, as can be understood by persons skilled in the art. When this occurs, during the encoding process, the selection of items may be collectively duplicated or referenced in more than one frames with the use of a “selection” entry.

An annotation entry 122 may contain a Type indicator 124 and a data section for the particular type of annotation item indicated by the Type indicator 124, as illustrated in FIG. 9. For example, assuming the annotation item is a line, Type indicator 124 may be set to “L” and the data section may include data for displaying the line item, as discussed below. If the item is an arrow, the type indicator may be set to “A”, and so on. A Select flag may also be provided to indicate whether any item is selected. When an item is selected, it may be displayed differently from an unselected item. For instance, a selected item may be highlighted and may be associated with one or more additional displayed objects to indicate that the selected item can be modified, such as being re-sized or relocated by a user with a mouse.

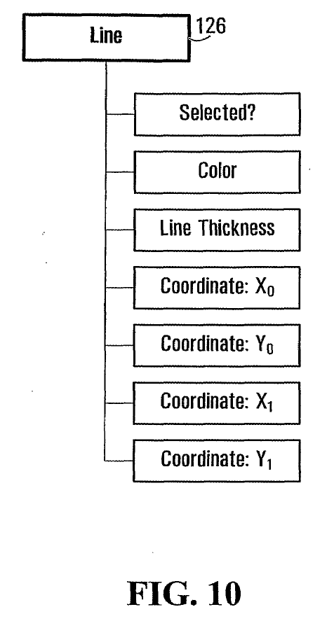

The data section for different types of items may contain different information depending on the item type. For example, as shown in FIG. 10, a line item 126 may contain a “selected” flag indicating whether this line item is in the selected state, and data indicating the color, thickness, and the coordinates of the terminal points (e.g. in the form of x₀, y₀, x₁, y₁) of the line to be displayed. The color data may include values indicating the alpha, red, green, and blue components to be displayed.

Similarly, an arrow item may contain data for indicating an arrow type, its selection status, color, line thickness, and coordinates of the terminal points or vertices.

A rectangle item, including a square, may contain data for indicating a rectangle type (such as by the letter “R”), its selection status, color, line thickness, coordinates of a base point, width, and height.

An ellipse item, including a circle, may contain data for indicating its type (such as by the letter “O” or “C”), selection status, color, line thickness, coordinates of a base point, a width and a height. The base point, width and height together define a rectangle or square whose lines are tangential to the ellipse to be displayed. Thus, the ellipse is defined. As can be appreciated, an ellipse may also be defined using a central point and the lengths of its major and minor axes.

A polygon item may contain data indicative of its type (such as by the letter “P”), its selection status, color, line thickness, and coordinates of all vertices.

A text item may contain data indicative of its type (such as by the letter “T”), selection status, color, font, coordinates for a boundary box, and the content of the text to be displayed.

A selection item contains data indicative of its type (such as by the letter “S”), selection status, and the selected region. For instance, the data may contain coordinates of a start point, a width, and a height of a selected box region.

As can be appreciated, for each of the above discussed annotation items, the item data described above is sufficient to define the properties of the annotation item to be displayed. It is not necessary to provide data for the annotation item on a pixel-by-pixel, or voxel-by-voxel, basis.

When all the annotation items in a frame are the same as in a previous frame, the annotation table may contain only a flag indicating such is the case. This also reduces the file size as redundant data storage is avoided.

As can be appreciated, the annotation table for a frame does not need to contain data for a complete annotation symbol. For example, the annotation table for a frame may contain data for a first half of an annotation symbol, and the annotation table for a next frame may contain data for the complete annotation symbol. A number of frame entries may also respectively contain data for an increasingly more complete symbol. When the corresponding frames are displayed in the correct sequence with correct timing, it would appear that the symbol is drawn from start to finish in real time, although each frame is a still image.

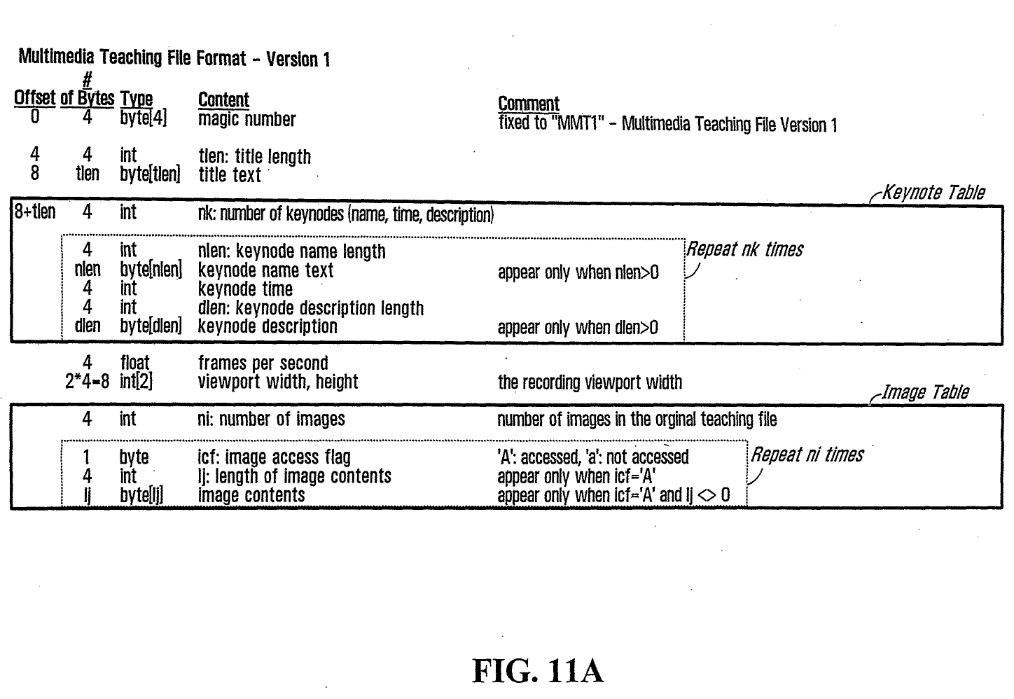

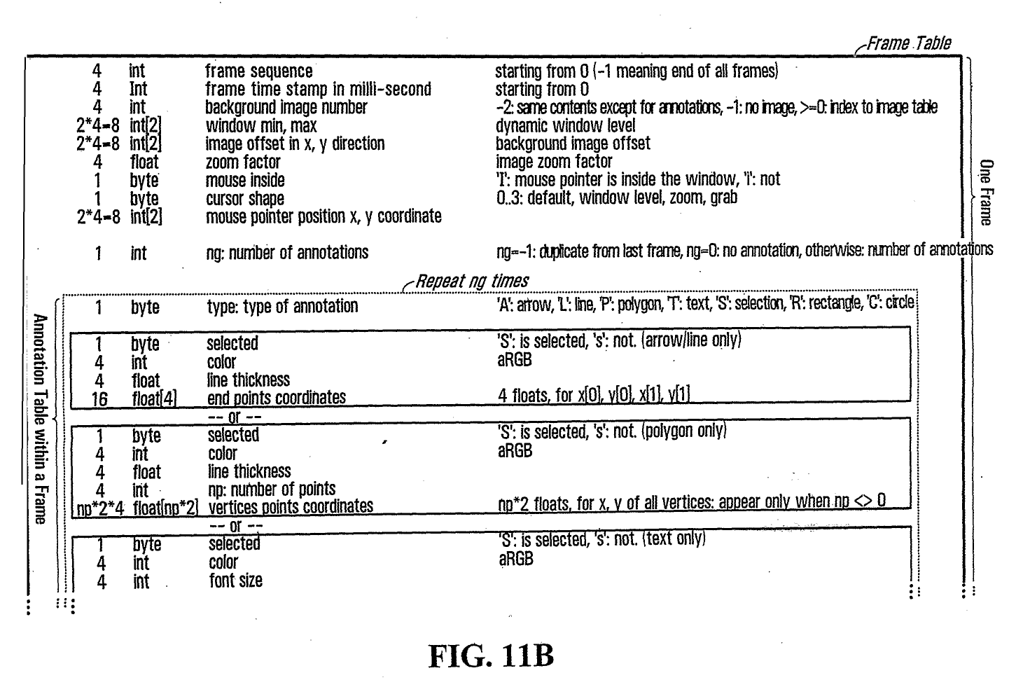

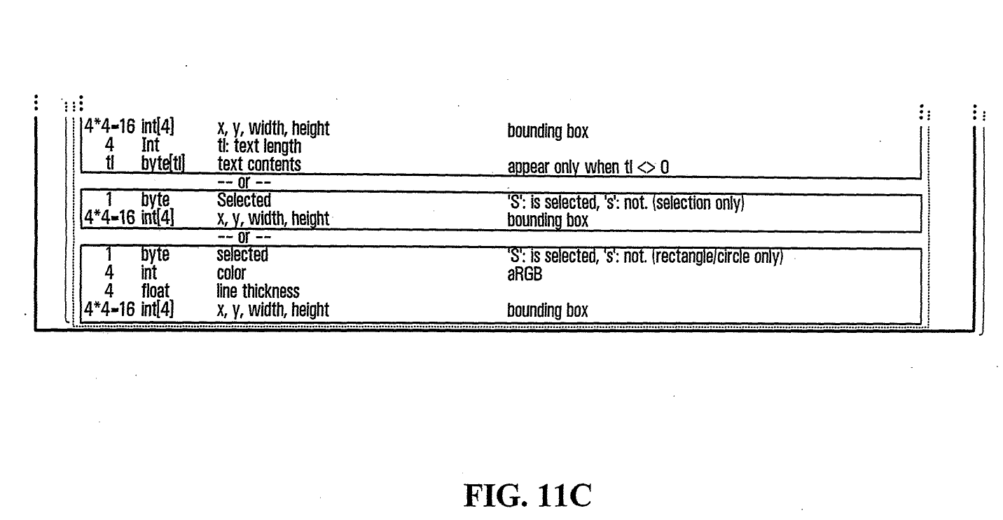

In a specific embodiment, an exemplary MMTF file has the format structure illustrated in FIGS. 11A to 11C. As can be understood, the various sections, tables and entries are indicated by bounding boxes. The numbers of data bytes allotted for each data field or entry are also indicated.

As can be appreciated, to create or generate an MMTF and present a display using the MMTF, a suitable MMTF encoder and an MMTF decoder may be used.

As can be appreciated, to create or generate an MMTF and present a display using the MMTF, a suitable MMTF encoder and an MMTF decoder may be used. For instance, the encoder may be adapted to read and parse a teaching file that comprises a pointer to a location where a radiology image file is stored, to retrieve the radiology image file from the location based on the pointer, and to generate an electronic file that stores an image table and image data copied from the radiology image file. The image table may be generated at least in part according to a pre-existing ETF such a conventional ETF for teaching radiology diagnosis. The encoder can also receive input data indicative of manipulation of a radiology image, generate a frame table based on the input data, and store the frame table in the electronic file. The encoder may be implemented using computer executable instructions, which may be stored on a computer readable storage medium, so that when the instructions are loaded at a computing device, the computing device is adapted to generate the electronic file. The encoder may also be implemented in part or wholly using an electronic circuit.

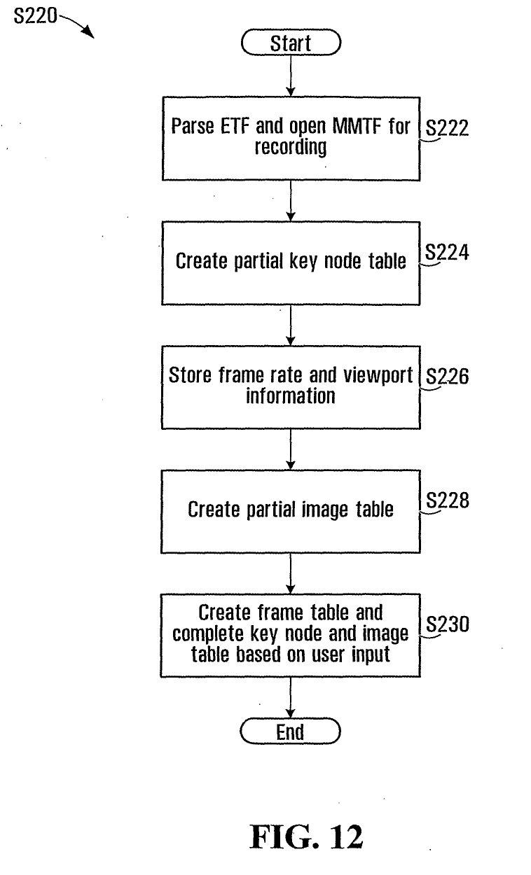

In an exemplary embodiment, the encoder may be adapted to perform the process S220 illustrated in FIG. 12. At S222, the encoder opens and parses the ETF. An MMTF visual file is opened for storing visual data. Optionally, an audio file may be opened for storing audio data. The audio data may be processed according a conventional technique and will not be further described. The visual file will be given a magic number and a title.

At S224, a partial key node table may be optionally created and stored. For instance, the structure and names of potential key nodes may be defined by the encoder or recording application and presented for user selection. The key node table may initially contain no key node entry. During the recording and encoding, a user may select a particular key node from the presented list of key node names and enter additional data such as description for the key node. The corresponding key node entry is then stored in the key node table, which may contain the key name, the description provided by the user, and the time at which the key node is selected or stored.

At S226, a frame rate, such as 10 or 15 frames/s, may be selected and stored. The frame rate may have a default value and may be set or reset by a user. Similarly, viewport information may be obtained and stored.

At S228, the encoder creates a partial image table containing image entries for all the radiology images listed in the ETF. The image entries are indexed and are each associated with an image index and an access flag which may be initially set to “a”.

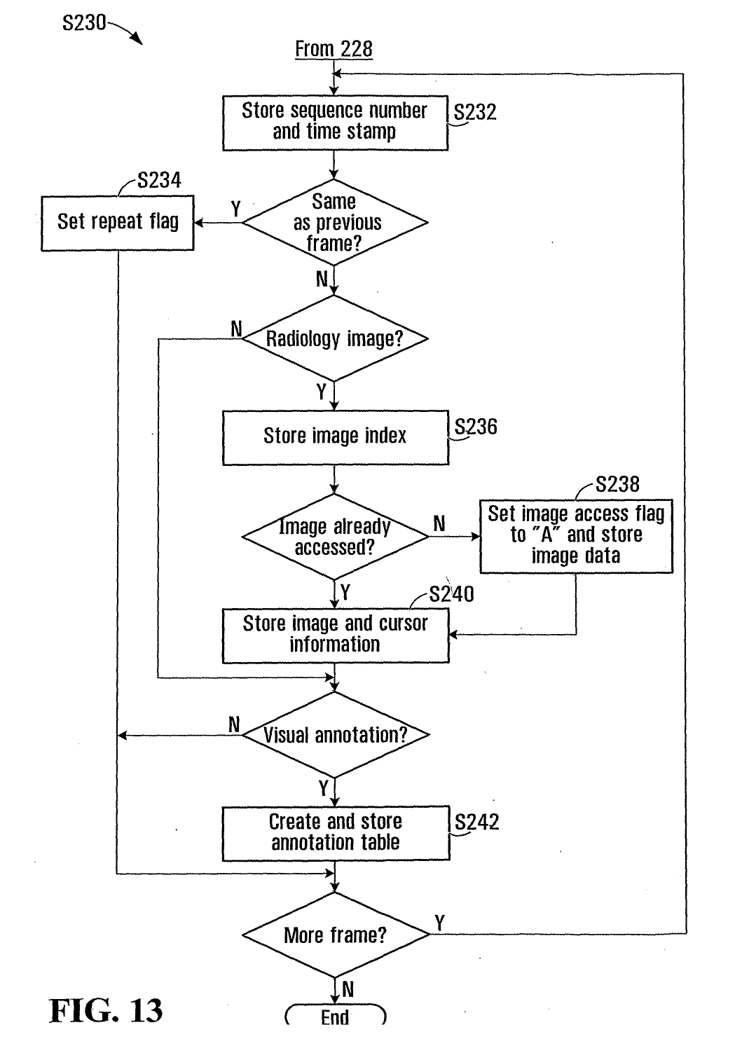

At S230, the encoder then awaits input from the user or another computer application and creates a frame table and completes the key node table and image table based on user input, as illustrated in FIG. 13.

A fixed number of frames per unit time are encoded and stored according to the pre-selected frame rate, such as 10 frames/s. Based on the frame rate, the screen display may be captured at fixed time intervals, such as every 0.1 s.

As illustrated in FIG. 13, for each captured screen snapshot, a frame entry is created and stored. The frame entries are sequentially numbered. At S232, the sequence number is stored in the frame entry. A timestamp is also stored which indicates the time of the snapshot is captured, relative to an absolute time or the timestamp of the first frame.

If the snapshot is identical to the previous snapshot, a flag indicating as such may be stored in the frame entry (at S234) and no more data need to be stored. Otherwise, additional data is stored as follows.

If the screen snapshot contains a radiology image, the corresponding image index will be stored in the frame entry (at S236). The access flag in the corresponding image entry is checked. If the flag has not been set to “A”, it is so set and the image data for the radiology image will be stored in the corresponding image entry (at S238). As now can be appreciated, since the image entries are sequentially indexed and the image indices are stored in frame entries, to delete an un-accessed image entry from the initial image table at the end of the encoding session will mean that the image entries are re-indexed and index numbers stored in the frame entries will need to be adjusted. To avoid such re-indexing, image entries for un-accessed images are kept in this embodiment. If the access flag has already been set to “A”, the radiology image has already been accessed and the corresponding image data has already been stored. The encoder can then proceed to the next step.

Regardless if the image has been accessed, corresponding image information and cursor information may be obtained and stored (at S240), as explained before.

If the screen snapshot contains visual annotation, an annotation table is created to store data for displaying the annotation (at S242), as described above. For instance, if the radiology image is displayed and manipulated on a computer, as described above, the annotation of the image may be recorded by tracking the movement of the cursor or any other drawing action, or by parsing the display buffer that stores the current display data. The annotation is recorded to reflect the currently displayed annotation in the screen snapshot. Thus, the frame entry contains annotation data for re-producing all the annotation items shown on the screen at the time.

If the snapshot contains no annotation, no annotation table is created.

The procedure is repeated for the next frame until the encoder receives a signal indicating that the session has finished.

As can be appreciated, in the above encoding process, the image table, the frame table and at least one annotation table are stored in a same electronic file. In different embodiments, the annotation tables may be stored in other manners such as independent of the frame table or frame entries. In some applications, it is sufficient if at least some of the frame entries are each associated with the radiology image to be displayed in the frame and each annotation table is associated with at least one of the frame entries. In some embodiments, an annotation table may be associated with multiple frame entries to further save storage space. Thus, in a different embodiment the encoder may store the image, frame and annotation tables separately, and associate each stored radiology image with a corresponding frame entry and associate each annotation table with a corresponding frame entry. In this case, it is not necessary that each frame entry contains an image number to associate the frame entry with its corresponding image entry. For example, an association table or database may be created for associating the frame entries with any corresponding images and annotation tables.

The decoder may be adapted to read and parse the MMTFs to receive the image table and frame table stored therein, and to present animated images according to the frame table and image table. The decoder may be implemented in part or in whole using an electronic circuit, or with software. The decoder reconstructs the frames for display from the visual file. Each constructed frame contains the corresponding radiology image formed from the corresponding image data and any annotation, if present, formed from the annotation data contained in the corresponding annotation table. Each frame is displayed at the time indicated by the timestamp of the corresponding frame entry, unless it is skipped due to frame rate constraint.

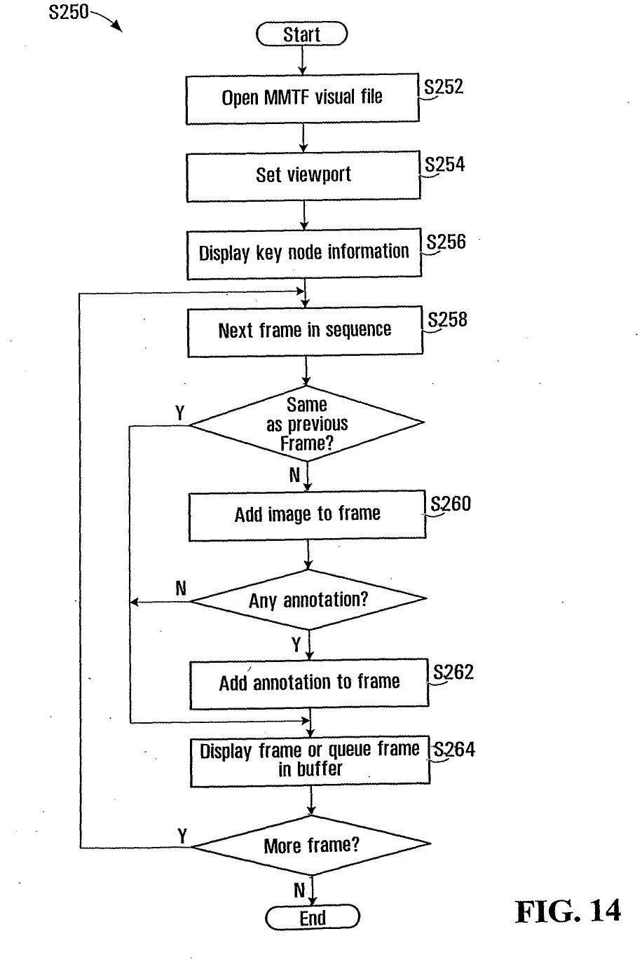

In one embodiment, a decoder such as the decoder portion of MMTF player 39 may be adapted to perform the process S250 illustrated in FIG. 14. Again, the following description of the exemplary encoder is limited to decoding visual MMTFs. The decoding of the audio file may be performed by the decoder in a conventional manner and will not be described further in detail.

At S252, the visual MMTF is opened and parsed.

At S254, the viewport is set according to the viewport entry in the file.

At S256, the key node information is retrieved and displayed for the first frame.

The frame table is then parsed to reconstruct the frames to be displayed. As can be appreciated, for good performance, later frames may be constructed as the early frames are being displayed. Further, a number of frames next to be displayed may be constructed and stored in a display buffer, such as in memory 24 of computer 20 when the encoder is run on computer 20. The number of frames stored in the display buffer may vary depending on the particular hardware and operating system used, and other factors.

The frames may be constructed in an order in according to the frame sequence number, or the timestamp. However, the frames may also be constructed randomly. As each frame entry has a sequence number and a timestamp, it is possible to randomly access the frame entries or to selectively start constructing the frames from any point in the sequence. For example, a user may select to start from a particular key node, which has a timestamp matches that of the a particular frame entry. The frame construction may then start from this particular frame entry. In this regard, the encoder may parse the MMTF and retrieve all of the sequence numbers and associated timestamps for all frame entries for later access.

When a frame entry contains a flag indicating that the frame is identical to the previous frame, no new frame need to be constructed. The previous frame is simply allowed to be displayed longer, or copied to the frame buffer for displaying (at S264).

If the frame is not the same as the previous frame, it may be checked if the image index number and image display information is the same as in the previous frame. If they are, the displayed image may be allowed to remain. If not, the image data from the corresponding image entry is retrieved and used to add the radiology image to the frame, according to the image information contained in the frame entry (at S260).

Next, the presence of any visual annotation is checked. If there is annotation to be displayed, the annotation table is parsed to add all annotation items to the frame (at S262).

The constructed frame is then displayed or queued in the display buffer (at S264).

This process may be repeated if there is any more frame to be processed. Optionally, when a next frame is processed, the key node information may be updated. If no more frame to be processed, the decoding process may end.

The encoder and decoder discussed above can be readily constructed by persons skilled in the art according to the teachings of this description. As discussed above, the encoder and decoder may be integrated and may be implemented using computer software, or hardware or a combination of both. For example, the encoder and decoder may be provided as standalone codec files, or integrated into a player application, such as MMTF player 39 shown in FIG. 1 (and FIG. 3) and described herein:

Software implementation of the encoder, decoder, or a codec may be programmed using any suitable computer language such as C, C++, Java++, and the like.

An MMTF encoder may be programmed to read an ETF, find all referenced radiology images and retrieve them, display the retrieved images to allow a user to manipulate the displayed image, record the user's manipulation on the displayed images optionally including any accompanying verbal instructions, and create an MMTF containing the data for presenting the teaching session just recorded, as described herein. The encoder may create one or more MMTF files for the same teaching session. As discussed above, in some embodiments, separate visual and audio files may be created for the same teaching session. A teaching session may involve the use of multiple ETFs and the encoder may handle the multiple ETFs consecutively or simultaneously and create one or more MMTFs associated with these ETFs. As can be understood, the encoder may be programmed to handle multiple threads of input, such as one thread for visual input and one thread for audio input. The two threads of input may be recorded synchronously or separately.

The MMTF decoder may decode the data in MMTFs and translate them into instructions and data executable by a receiving computer operating environment such as under the Microsoft™ Windows™ or Vista™, or Apple™ MAC OS X™ Unix, Linux, or the like. The decoder or player may also be implemented using Java script, such as in the form of a Java applet, so that the decoder may be executed on different operating systems and platforms. As can be understood, the decoder or MMTF player may be programmed to handle multiple threads of input, such as one thread for visual input and one thread for audio input, respectively from the video and audio MMTFs. The two threads may be replayed synchronously or separately.

Program codes for the MMTF decoder, encoder or player may be stored on memory 24 so that when they are loaded at a computing device such as processor 22 of computer 20 they adapt the computing device to perform the processes and methods described herein, or any portion of thereof.

As discussed above, in different embodiments, an MMTF encoder or decoder may be entirely or partially implemented using an electronic circuit, as can be understood by persons skilled in the art. An electronic circuit is to be broadly interpreted and may include any electronic devices that can process an input signal and produce an output signal based on the input signal. For instance, a processor is a circuit. The decoder and encoder may be provided as a standalone device, or be integrated within a computing device such as a computer.

The MMTFs and other embodiments of the present application may be useful in a variety of applications. As can be appreciated, the MMTFs may be conveniently used to teach and study radiology diagnosis. A user may either play the MMTFs from a location remote from the location where the MMTF is created, or play the MMTF at a later time after the MMTF is created. Many users may create different MMTFs and store them in a depository or database so that comprehensive teaching files may be made available over time. MMTFs may also be conveniently revised by another user, or different MMTFs created by different uses may be combined, so that collaborated or distributed teaching may be provided. The MMTFs They may also be conveniently used in online discussion forums. For example, participants in an online discussion forum or a teleconference may exchange MMTFs through a network to assist communication of information.

Further, while embodiments of the present invention are illustrated above using computers 30 and 34, it will be appreciated that other types of computing devices or electronic devices may also be used. For example, a displaying device, such as TVs, projectors, DAD players, and the like, may be used to play or display animated images from an MMTF teaching file.

Other features, benefits and advantages of the embodiments described herein not expressly mentioned above can be understood from this description and the drawings by those skilled in the art.

Of course, the above described embodiments are intended to be illustrative only and in no way limiting. The described embodiments are susceptible to many modifications of form, arrangement of parts, details and order of operation. The invention, rather, is intended to encompass all such modification within its scope, as defined by the claims.

1. A method of storing electronic data for presenting images to teach radiology diagnosis, the method comprising:
storing on a computer readable storage medium an image table that comprises indexed radiology images to be displayed;
storing on a computer readable storage medium a frame table that comprises frame entries, each for displaying a frame in a sequence of frames to be displayed and comprising
a time indicator indicating a time to display the frame in the sequence, and display state data indicating a display state of one of the radiology images to be displayed in the frame;
storing on a computer readable storage medium at least one annotation table comprising data defining teaching annotations to be superimposed on at least one of the radiology images;
associating each frame entry with one of the radiology images; and
associating each annotation table with one of the frame entries.

2. The method of claim 1, wherein the tables are stored in an electronic file for teaching radiology diagnosis.

3. The method of claim 1, wherein the tables are generated, at least in part, to record a user's visual manipulation of the radiology images.

4. The method of claim 1, wherein at least one of the radiology images is copied from a pre-existing image data file.

5. The method of claim 4, wherein the image table is generated at least in part according to a pre-existing electronic teaching file, the teaching file comprising a reference to the image data file.

6. The method of claim 4, wherein the image data file is stored in a database.

7. The method of claim 1, wherein the teaching annotations comprise one or more annotation items selected from among an arrow, a line, a polygon, an ellipse, and a text string.

8. The method of claim 7, wherein the line is a straight line, and the polygon is a triangle, or a square, or a rectangle.

9. The method of claim 1, comprising storing audio data for presenting audio instructions synchronously with the sequence of frames.

10. The method of claim 9, wherein the audio data is stored in an audio data file.

11. The method of claim 1, further comprising storing a frame rate indicator indicating a number of frames to be displayed in a unit time.

12. The method of claim 1, further comprising storing viewport data indicating a viewport for the frames.

13. The method of claim 1, further comprising storing a key node table, the key node table comprising one or more key node entries, each key node entry comprising a description of a key node and a time indicator that matches a time indicator of a frame entry associated with the each key node.

14. The method of claim 1, wherein each frame entry comprises a sequence number.

15. The method of claim 1, wherein each frame entry comprises cursor data for displaying a cursor.

16. The method of claim 1, wherein the at least one annotation table comprises at least one annotation entry, each annotation entry comprising annotation data for displaying an annotation item.

17. The method of claim 16, wherein each annotation entry comprises a type indicator indicating a type of an annotation item in the annotation entry.

18. The method of claim 1, wherein each frame entry comprises an image indicator indicating an image index of a radiology image associated with the frame entry.

19. The method of claim 1, wherein the display state data comprises an indicator of at least one of brightness, contrast, and a zoom factor for an associated image.

20. A method of presenting images using data stored according to the method of claim 1, comprising:
displaying the sequence of frames based on the tables, wherein a particular one of the frames is displayed by
displaying a radiology image associated with the corresponding frame entry according to the corresponding frame entry, and
superimposing a teaching annotation on the radiology image according to an annotation table associated with the corresponding frame entry.

21. The method of claim 20, wherein the particular frame is displayed at a time indicated by the time indicator of the corresponding frame entry.

22. The method of claim 20, further comprising presenting an audio annotation based on stored audio annotation data, as the frames are displayed.

23. The method of claim 22, the audio annotation is presented in synchronization with presentation of the sequence of frames.

24. A computer readable storage medium storing data for presenting images to teach radiology diagnosis, the data comprising:
an image table that comprises indexed radiology images to be displayed;
a frame table that comprises frame entries, each for displaying a frame in a sequence of frames to be displayed and comprising
a time indicator indicating a time to display the frame in the sequence,
an image indicator indicating an image index to associate the frame with one of the radiology images to be displayed in the frame, and
display state data indicating a display state of one of a the radiology images to be displayed in the frame; and
at least one annotation table comprising data defining teaching annotations to be superimposed on at least one of the radiology images, wherein each annotation table is associated with one of the frame entries.

25. The computer readable storage medium of claim 24, wherein the data is stored in an electronic file.

26. The computer readable storage medium of claim 24, wherein the teaching annotations comprising one or more annotation items selected from among an arrow, a line, a polygon, an ellipse, and a text string.

27. The computer readable storage medium of claim 26, wherein the line is a straight line, and the polygon is a triangle, or a square, or a rectangle.

28. The computer readable storage medium of claim 24, further storing audio data for presenting audio annotation of the radiology images.

29. The computer readable storage medium of claim 24, wherein the data comprises a frame rate indicator indicating a number of frames to be displayed in a unit time.

30. The computer readable storage medium of claim 24, wherein the data comprises viewport data indicating a viewport for the frames.

31. The computer readable storage medium of claim 24, wherein the data comprises a key node table, the key node table comprising one or more key node entries, each key node entry comprising a description of a key node and a time indicator that matches a time indicator of a frame entry associated with the each key node.

32. The computer readable storage medium of claim 24, wherein each frame entry comprises a sequence number.

33. The computer readable storage medium of claim 24, wherein each frame entry comprises cursor data for displaying a cursor.

34. The computer readable storage medium of claim 24, wherein the at least one annotation table comprises at least one annotation entry, each annotation entry comprising annotation data for displaying an annotation item.

35. The computer readable storage medium of claim 34, wherein the each annotation entry comprises a type indicator indicating a type of an annotation item in the annotation entry.

36. The computer readable storage medium of claim 24, wherein the display state data comprises an indicator of at least one of brightness, contrast, and a zoom factor for an associated image.

37. An apparatus for teaching radiology diagnosis, comprising
the computer readable storage medium of claim 24; and
a display in communication with the computer readable storage medium for displaying images based on the data.
